(19) United States
(12) Patent Application Publication
(10) Pub. No.: US 2013/0106340 A1
(43) Pub. Date: May 2, 2013

(54) ELECTRIC MOTOR, STEERING DEVICE AND METHOD

(71) Applicants: Antoine Chabaud, Tamm (DE); Pascal Hiry, Vaihingen/Enz (DE)

(72) Inventors: Antoine Chabaud, Tamm (DE); Pascal Hiry, Vaihingen/Enz (DE)

(73) Assignee: ROBERT BOSCH GMBH, Stuttgart (DE)

(21) Appl. No.: 13/699,767

(22) PCT Filed: May 4, 2011
(86) PCT No.: PCT/EP2011/057129

§ 371 Date: Jan. 17, 2013

(30) Foreign Application Priority Data
May 27, 2010 (DE) 102010029332.6

(51) Int. Cl. H02P 6/00

(52) U.S. Cl. CPC H02P 6/00
USPC 318/806

(57) ABSTRACT

The invention relates to an electronically commutated electric motor. The electronically commutated electric motor comprises a stator and a rotor, which in particular is designed to be permanently magnetic. The electric motor also comprises a rotor position sensor, wherein the rotor position sensor is designed to detect a predetermined number of in particular discrete, rotor positions along a rotational direction of the rotor. The rotor position sensor is also designed to generate a sensor signal representing the rotor positions. The electric motor also comprises a control unit connected to the rotor position sensor, wherein the control unit is designed to actuate the stator in order to generate a magnetic rotary field in dependence on the sensor signal. According to the invention, the control unit comprises an input for a steering angle signal, in particular an analog or digital steering angle signal, which represents a steering angle of a vehicle steering system. The control unit is designed to additionally actuate the stator depending on the steering angle signal.

### BACKGROUND OF THE INVENTION

The invention relates to an electronically commutated electric motor. The electronically commutated electric motor has a stator and a rotor which is, in particular, of permanent magnetic design. The electric motor also has a rotor position sensor, wherein the rotor position sensor is designed to sense a predetermined number of, in particular, discrete rotor positions in a rotational direction of the rotor.

The rotor position sensor is also designed to generate a sensor signal which represents the rotor positions. The electric motor also has a control unit which is connected to the rotor position sensor, wherein the control unit is designed to actuate the stator in order to generate a magnetic induction field as a function of the sensor signal.

In the case of electronically commutated electric motors which are known from the prior art, for example in the case of electric motors which are used to generate an assisting steering torque in a power steering system, in order to control the torque and to generate the rotational movement of the rotor the rotor position is sensed by means of at least one rotor position sensor, for example by means of a Hall sensor, an AMR (Anisotrope Magneto-Resistive) sensor or a GMR (Giant Magneto-Resistive) sensor.

The number of rotor positions which can be sensed by means of such rotor position sensors depends, for example when using Hall sensors, on the number of rotor position sensors and/or on a pole number of a signal generator magnet which are connected to the electric motor as components of the electric motor.

### SUMMARY OF THE INVENTION

According to the invention, the control unit has an input for a steering angle signal, in particular, in analog or digital steering angle signal which represents a steering angle of a vehicle steering system. The control unit is designed to actuate the stator additionally as a function of the steering angle signal. By means of the additional actuation of the rotor as a function of the steering angle signal, the control unit can advantageously use at least one further parameter, specifically the steering angle signal, to generate the magnetic induction field.

The electric motor is, for example, a synchronous machine or an asynchronous machine.

The control unit is formed, for example, by a microprocessor, a microcontroller or a FPGA (Field Programmable Gate Array).

In one preferred embodiment, the control unit is designed to determine at least one rotor position of the rotor as a function of the steering angle signal. The control unit can have for this purpose, for example, at least one computing unit and a time signal generator which is connected to the computing unit. The control unit is also preferably designed to determine at least one rotor position according to a predetermined step-down ratio.

For example, ten rotor rotations of the electric motor therefore correspond to one rotation of five degrees of a vehicle steering wheel. Steering angle sensors are advantageously used in vehicles for supplying an input parameter of an ESP system. As a result, it is advantageously possible to increase the resolution of a rotor-position-sensing means compared to merely using a rotor position sensor. It is also advantageous that a sensing angle range of a rotor-position-sensing means can be increased along a rotor circumference compared to actuation alone as a function of the sensor signal of the rotor position sensor.

For this purpose, in vehicles which are equipped with a steering angle sensor, it is therefore possible for the control unit to determine further rotor positions additionally as a function of the rotor positions which have been sensed by the rotor position sensor. In order to actuate the electric motor there is therefore a rotor position signal with high resolution available in a way which is favorable in terms of expenditure since further rotor position sensors do not have to be used to increase angular resolution of the rotor position sensor.

The rotor position sensor is, for example, designed to sense two, three or up to four rotor positions along a rotor circumference of the rotor.

By means of the control unit which is embodied in this way it is advantageously possible to determine, in addition to the two, three or up to four rotor positions along the rotor circumference, further rotor positions as a function of the steering angle signal.

The rotor position sensor has, for example, at least one Hall sensor. In another embodiment, the rotor position sensor can have at least one AMR sensor or at least one GMR sensor.

In one preferred embodiment, the steering angle signal is an, in particular, analog signal which is continuous over time. In this embodiment, the control unit preferably has an analog/digital converter which is connected to the input for the steering angle signal. The control unit is designed to generate a rotor position signal from the sensor signal and the steering angle signal and to actuate the stator as a function of the generated rotor position signal.

The analog/digital converter is preferably designed to sense the analog steering angle signal, quantize it and generate a digital output signal.

The invention also relates to a steering device having an electric motor of the type described above. The steering device, also referred to below as steering arrangement, has the steering angle sensor which is designed to sense a steering angle of a vehicle steering system and to generate the steering angle signal. The steering angle signal represents a steering angle of a vehicle steering system, in particular of a vehicle steering wheel.

Furthermore, the steering device is also preferably designed to generate a steering torque which assists steering of the vehicle.

The invention also relates to a method for operating a steering device for a motor vehicle. In the method, a steering torque which assists steering is generated by means of an electronically commutated electric motor. In the method, a predetermined number of, in particular, discrete rotor positions is also sensed in a rotational direction of a rotor of the electric motor. In the method, a sensor signal which represents the rotor positions is also generated, and a magnetic induction field for generating the assisting steering torque is generated as a function of the sensor signal.

According to the invention, in the method an, in particular, analog or digital steering angle signal which represents a steering angle of the steering device is generated and the magnetic induction field for generating the assisting steering torque is additionally generated as a function of the steering angle signal.

A steering angle signal can be improved in terms of resolution and/or sensing angle range as a function of a rotor position signal independently of or in addition to the inventive concept of improving a rotor-position-sensing means in terms of resolution and/or sensing angle range as a function of a steering angle signal.

### BRIEF DESCRIPTION OF THE DRAWINGS

FIG. 1 shows an exemplary embodiment of a steering arrangement for a motor vehicle;

FIG. 2 shows an exemplary embodiment of a method for operating a steering arrangement for a motor vehicle;

FIG. 3 shows an exemplary embodiment of a rotor position signal which comprises both sensor signals generated by a rotor position sensor and rotor position signals calculated from a steering angle signal which is generated by a steering angle sensor.

### DETAILED DESCRIPTION

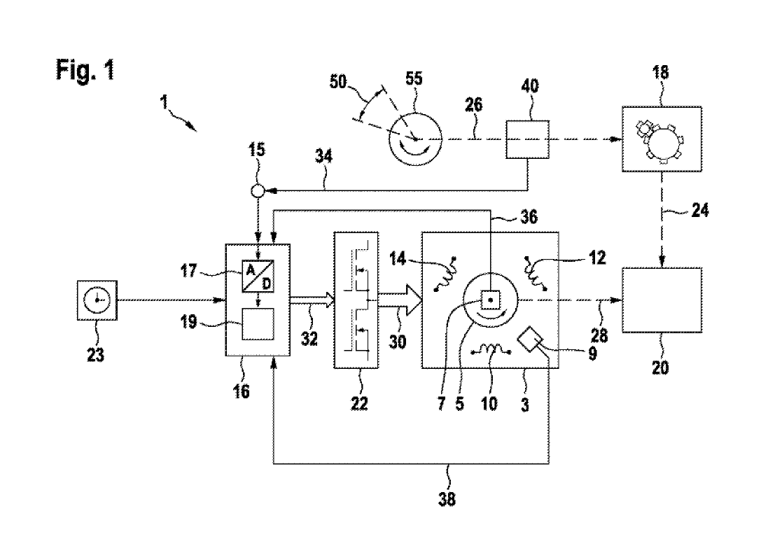

FIG. 1 shows an exemplary embodiment of a steering arrangement 1 for a motor vehicle. The steering arrangement 1 has an electronically commutated electric motor with a stator 3 and a rotor 5. The rotor 5 is of permanent magnetic design in this exemplary embodiment. The electric motor also has a rotor position sensor 7. The rotor position sensor 7 is embodied as an AMR sensor. In addition to or as an alternative to the rotor position sensor 7, the electric motor can have a rotor position sensor 9 which is embodied as a Hall sensor in this exemplary embodiment.

The stator 3 of the electric motor comprises stator coils, in this exemplary embodiment three stator coils 10, 12 and 14.

The steering arrangement 1 also has a control unit 16 which is connected to a power output stage 22 via a connection 32. The power output stage 22 has, for example, an H bridge for each of the stator coils 10, 12 and 14. In the case of an H bridge, a stator coil is connected by one terminal to an output of a transistor half-bridge and by another terminal to an output of a second transistor half-bridge.

In another embodiment, the power output stage has a B6 bridge. In the case of a B6 bridge, an output of a transistor half-bridge is connected to a terminal of an exciter coil, and a second terminal of the exciter coil is, depending on the connection of the exciter coils, connected to the second terminals of the other exciter coils in the case of a star circuit. In the case of a triangular circuit it is connected to a first terminal of another exciter coil.

The transistors may, for example, each be embodied as a MOS-FET (MOS-FET=metal oxide semiconductor field effect transistor), as a MIS-FET (MIS=metal insulator semiconductor), as a bipolar transistor, as a JFET (JFET=junction FET), as an IGBT (IGBT=insulated gate bipolar transistor), as an HEMT (HEMT=high electron mobility transistor), or as an HBT (HBT—heterojunction bipolar transistor).

The output stage 22 is connected on the output side, via a connection 30, to the stator 3 and there to the stator coils 10, 12 and 14. The power output stage 22 is designed to energize, as a function of a control signal received on the input side via the connection 32, the stator coils 10, 12 and 14 of the stator 3 in order to generate a magnetic induction field. The control unit 16 is designed to generate the control signals in order to generate the magnetic induction field, and to correspondingly actuate the power output stage 22 via the connection 32. The control unit 16 also has an analog/digital converter 17. The analog/digital converter 17 is connected on the output side to a computing unit 19 of the control unit 16. The control unit 16 also has an input 15 for a steering angle signal, which input 15 is connected to the analog/digital converter 17. The steering arrangement 1 also has a steering angle sensor 40 which is operatively connected to a steering shaft 26. The steering angle sensor 40 is designed to sense a rotation, in particular an angle of rotation of a steering wheel or of the steering shaft, in particular steering column, and to generate a steering angle signal which represents the steering angle and to output said steering angle signal on the output side. The steering angle sensor 40 is connected for this purpose on the output side to the input 15 of the control unit 16 via a connecting line 34. The control unit is also connected on the input side to a time signal generator 23. The time signal generator 23 is designed to generate a time signal as a time base for calculating the rotor positions from the steering angle signal and to output said time signal on the output side to the control unit 16. The time signal generator 23 has, for example, an oscillatory quartz.

The steering arrangement 1 also has a steering wheel 55 which is rotatably connected to a steering gear 18 via the steering shaft 26.

The steering gear 18 is connected to a vehicle steering system 20 via a shaft 24. The vehicle steering system 20 is also rotatably connected to the rotor 5 of the electric motor via a shaft 28.

The rotor 5 of the electric motor is designed to generate, as a function of the magnetic induction field, a steering torque for steering a vehicle, which steering torque can effectively assist a steering torque which is generated by the steering wheel 55.

The steering angle 50, which may have been sensed by the steering angle sensor 40, is also illustrated.

The method of operation of the steering arrangement 1 will now be explained below:

If a user of the vehicle generates a steering torque by means of the steering wheel 55 and in the process rotates the steering wheel 55 through the steering angle 50, the steering angle sensor 40 can sense the steering angle 50 and generate an, in particular, analog steering angle signal which represents the steering angle.

The control unit 16 can sample the steering angle signal received at the input 15 by means of the analog/digital converter 17 and quantize it and output the steering angle signal, which is sampled and quantized in this way, to the computing unit 19. The computing unit 19 is designed to convert, as a function of the time signal received by the time signal generator 23, the steering angle signal received by the analog/digital converter 17, in accordance with a predetermined step-down ratio, into a rotor position, in particular a rotor angle of a rotation of the rotor 5.

The control unit 16 is also connected via a connecting line 36 to a rotor position sensor 7 on the input side. The rotor position sensor 7 is designed to sense at least one rotor position, in this exemplary embodiment 2 rotor positions of the rotor 5, and to output on the output side a sensor signal which represents the rotor position of the rotor 5.

The rotor position sensor 7 is, for example, an AMR sensor or a GMR sensor. For example, the GMR sensor or the AMR sensor is designed to generate an analog rotor position signal which is continuous over time and is connected to an analog/digital converter. Angular resolution of the rotor position sensor is then determined by a sampling rate of an analog/digital converter which converts the analog rotor position signal from analog to digital. In the case of a rotor position sensor in the form of at least one Hall sensor, the angular resolution is determined by the number of the Hall sensors.

The control unit 16 is designed to generate the control signals for generating the magnetic induction field as a function of the sensor signal which is generated by the rotor position sensor 7 and/or by the rotor position sensor 9.

The control unit 16 is designed to generate a rotor position signal for generating the magnetic induction field, which rotor position signal comprises both the rotor positions sensed by the rotor position sensor 7 and/or by the rotor position sensor 9 and rotor positions calculated by the computing unit 19 as a function of the steering angle signal according to the step-down ratio.

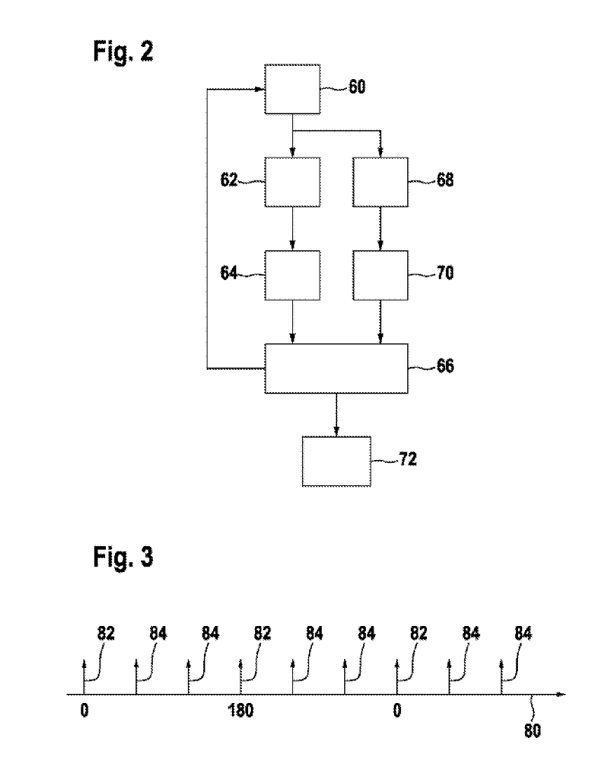

FIG. 2 shows an exemplary embodiment of a method for operating a steering arrangement of a motor vehicle, in particular of the steering arrangement 1 illustrated in FIG. 1.

In the method, a time signal generator, for example the time signal generator 23 illustrated in FIG. 1, is started in a step 60. In a step 62, a predetermined number of, in particular, discrete rotor positions in a rotational direction of a rotor of the electric motor is sensed as a time base as a function of the step 60, and in a step 64 a sensor signal which represents the rotor positions is generated. In a step 68, a steering angle of a vehicle steering system of the motor vehicle is sensed as a time base as a function of the step 60, and a steering angle signal which represents the steering angle is generated. In a step 70, a change in rotor position of a rotor position of the rotor is determined from the steering angle signal according to a predetermined assignment rule, in particular according to a step-down ratio, and a signal which represents the change in rotor position is generated. In a step 66, a rotor position signal, which has both rotor positions sensed by the rotor position sensor and rotor positions calculated from the steering angle signal, is generated from the rotor position signal generated in step 64 and the signal which is generated in step 70 and represents the change in rotor position.

In a step 72, and the magnetic induction field for generating the assisting steering torque is generated as a function of the rotor position signal which is generated in step 66.

At step 66 it is possible, for example after a rotor rotation or a predetermined number of rotor rotations, for the time signal generator to be started again in step 60.

FIG. 3 shows an exemplary embodiment of a rotor position signal which the control unit illustrated in FIG. 1 for generating the magnetic induction field has generated in order to assist steering of a vehicle.

A time axis 80, on which rotor positions 82 are plotted, is illustrated. The rotor positions 82 have been sensed by the rotor position sensor 7 illustrated in FIG. 1 and/or the rotor position sensor 9. In addition to the rotor positions 82, the rotor position signal comprises rotor positions 84 which have been generated by the computing unit (illustrated in FIG. 1) as a function of the steering angle signal. It is apparent that a sampling rate of the rotor position of the rotor 5 which is illustrated in FIG. 1 by means of the steering angle signal, which has been received by the control unit 16 at the input 15 and converted into further rotor positions by the computing unit 19 as a function of the step-down ratio, is higher than the sampling rate represented by the rotor positions 82 alone.

1. An electronically commutated electric motor (3, 5, 7, 9) comprising a stator (3) and a rotor (5), wherein the electric motor (3, 5, 7, 9) has a rotor position sensor (7, 9) which is designed to sense a predetermined number of discrete rotor positions (82) in a rotational direction (80) of the rotor (5) and to generate a sensor signal which represents the rotor positions (82), and comprising a control unit (16) which is connected to the rotor position sensor (7, 9) and is designed to actuate the stator in order to generate a magnetic induction field as a function of the sensor signal (82), characterized in that the control unit (16) has an input (15) for a steering angle signal which represents a steering angle of a vehicle steering system, the control unit (16) configured to actuate the stator (3) based on the steering angle signal (84).

2. The electronically commutated electric motor (3, 5, 7, 9) as claimed in claim 1, characterized in that the control unit (16) is designed to determine at least one rotor position (84) of the rotor (5) as a function of the steering angle signal.

3. The electronically commutated electric motor (3, 5, 7, 9) as claimed in claim 2, characterized in that the control unit (16, 19) is designed to determine the at least one rotor position (84) according to a predetermined step-down ratio.

4. The electronically commutated electric motor (3, 5, 7, 9) as claimed in claim 1, characterized in that a detected angle along a rotor circumference is increased as a function of the sensor signal of the rotor position sensor.

5. The electronically commutated electric motor (3, 5, 7, 9) as claimed in claim 1, characterized in that the rotor position sensor (7, 9) is designed to sense up to four rotor positions along a rotor circumference (80) of the rotor (5).

6. The electronically commutated electric motor (3, 5, 7, 9) as claimed in claim 1, characterized in that the rotor position sensor (9) has at least one Hall sensor.

7. The electronically commutated electric motor (3, 5, 7, 9) as claimed in claim 1, characterized in that the rotor position sensor (7) is an AMR sensor.

8. The electronically commutated electric motor (3, 5, 7, 9) as claimed in claim 1, characterized in that the steering angle signal is an analog signal which is continuous over time.

9. The electronically commutated electric motor (3, 5, 7, 9) as claimed in claim 1, characterized in that the control unit (16) has an analog/digital converter (17) which is connected to the input (15) for the steering angle signal, wherein the control unit (16) is designed to generate a rotor position signal from the sensor signal (82) and the steering angle signal (84) and to actuate the stator as a function of the generated rotor position signal.

10. A steering device (1) having an electric motor (3, 5, 7, 9) as claimed in claim 1, characterized in that the steering device (1) has a steering angle sensor (40) which is designed to sense a steering angle (50) of a vehicle steering system (55) and to generate the steering angle signal.

11. A method for operating a steering device for a motor vehicle, in which a steering torque which assists steering of the motor vehicle is generated by means of an electronically commutated electric motor and in which a predetermined number of discrete rotor positions (82) is sensed in a rotational direction (82) of a rotor (5) of the electric motor (3, 5, 7, 9), and a sensor signal which represents the rotor positions (82) is generated, and a magnetic induction field for generating the assisting steering torque is generated as a function of the sensor signal, characterized in that a steering angle signal which represents a steering angle of a vehicle steering system is generated and the magnetic induction field for generating the assisting steering torque is additionally generated as a function of the steering angle signal (84).

12. The electronically commutated electric motor (3, 5, 7, 9) as claimed in claim 1, wherein the rotor (5) is a permanent magnet.

13. The electronically commutated electric motor (3, 5, 7, 9) as claimed in claim 1, wherein the steering angle signal is an analog signal.

14. The electronically commutated electric motor (3, 5, 7, 9) as claimed in claim 1, wherein the steering angle signal is a digital signal.

15. The electronically commutated electric motor (3, 5, 7, 9) as claimed in claim 1, wherein the rotor position sensor (7) is an AMR sensor.

16. The electronically commutated electric motor (3, 5, 7, 9) as claimed in claim 1, wherein the rotor position sensor (7) is an GMR sensor.

17. The method as claimed in claim 11, wherein the steering angle signal is an analog signal.

18. The method as claimed in claim 11, wherein the steering angle signal is a digital signal.
